(19) United States
(12) Patent Application Publication
(10) Pub. No.: US 2008/0185247 A1
(43) Pub. Date: Aug. 7, 2008

(54) SEALING STRUCTURE FOR SELF LEVELING DAMPER UTILIZING QUADRANGULAR-SECTIONED O-RING

(75) Inventor: Tae Ju Kim, Iksan-si (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Seoul (KR)

(21) Appl. No.: 12/025,457

(22) Filed: Feb. 4, 2008

(30) Foreign Application Priority Data
Feb. 5, 2007 (KR) 10-2007-0011646

(51) Int. Cl. F16F 9/36

(52) U.S. Cl. 188/322.16

(57) ABSTRACT

There is provided a sealing structure for hermetically sealing a gap between a base valve and an internal cylinder in a self leveling damper, which includes internal and external cylinders, a piston valve and a piston rod provided in the internal cylinder, and a base valve provided in a distal end of the internal cylinder, to absorb vibration transmitted from a road to an axle when a vehicle is driven, wherein a quadrangular-sectioned O-ring is inserted into a circular groove formed on a body of the base valve to hermetically seal the gap between the base valve and the internal cylinder.

### BACKGROUND

1. Technical Field

The present invention relates to a sealing structure of a self leveling damper, and more particularly, to a sealing structure of a self leveling damper, in which a quadrangular-sectioned O-ring is employed so that the O-ring can be prevented from escaping and a sealing status of the O-ring can be stably maintained.

2. Description of the Related Art

In general, a damper is a shock-absorbing device provided between an axle and a vehicle body to absorb vibration or shock transmitted from a road to the axle for enhancing ride comfort. An interior of the damper is filled with filler, such as gas, oil or the like, to increase damping force.

However, height of a vehicle capable of transporting a relatively large number of passengers or a relatively large amount of freight is changed depending on the number of passengers or the amount of freight. Such a change of the height of the vehicle degrades the ride comfort and handling stability of the vehicle. Accordingly, a self leveling damper, which can maintain the height of a vehicle constantly regardless of a change of weight thereof, has been developed and utilized.

FIG. 1 is a partial sectional view of an upper portion of a conventional reverse type self leveling damper, and FIG. 2 is an enlarged sectional view showing a sealing structure of the conventional self leveling damper shown in FIG. 1.

As shown in FIG. 1, the conventional self leveling damper has a basic structure comprising internal and external cylinders 11 and 13, a piston valve (not shown) and a piston rod (not shown) provided in the internal cylinder for generating a damping force, and a base valve 15 in which oil flows.

In addition thereto, the conventional self leveling damper further comprises a pump tube (not shown) provided in the piston rod and extending to the piston valve, a discharge valve (not shown) installed at a distal end of the pump tube, a pump rod 17 provided in the pump tube to pass though the piston valve and extend to the base valve 15, and a suction valve (not shown) mounted at a distal end of the pump rod 17.

As shown in FIG. 1, a distal end of the internal cylinder 11 is round, and the base valve 15 is provided in the distal end of the internal cylinder 11. An O-ring 19 for sealing is mounted between the base valve 15 and the internal cylinder 11.

In order to mount the O-ring 19, as shown in FIG. 2, a body of the base valve 15 is formed with a circular groove 16 having an inner diameter of 26.8 mm, a width of 2.7 mm and a depth of 1.5 mm, and the circular-sectioned O-ring 19 to be inserted in the circular groove 16 has an inner diameter of 25.5 mm and a diameter of a cross-section of 2.0 mm. Accordingly, in order to insert the O-ring 19 into the circular groove 16, the O-ring 19 should be expanded to increase the diameter thereof by approximately 1.3 mm and then inserted into the circular groove 16.

However, if oil and gas are injected into the assembled self leveling damper according to the conventional sealing structure, pressure is exerted against the O-ring 19 provided between the base valve 16 and the internal cylinder 11 inwardly from the outside. There is concern that such a pressure can cause the O-ring to escape from the circular groove.

### BRIEF SUMMARY

An object of the present invention is to provide a sealing structure of a self leveling damper, in which a quadrangular-sectioned O-ring is mounted between a base valve and an inner cylinder for hermetically sealing a gap therebetween so that the O-ring can be prevented from escaping and a sealing status of the O-ring can be stably maintained.

According to the present invention, there is provided a sealing structure for hermetically sealing a gap between a base valve and an internal cylinder in a self leveling damper, which includes internal and external cylinders, a piston valve and a piston rod provided in the internal cylinder, and a base valve provided in a distal end of the internal cylinder, to absorb vibration transmitted from a road to an axle when a vehicle is driven, wherein a quadrangular-sectioned O-ring is inserted into a circular groove formed on a body of the base valve to hermetically seal the gap between the base valve and the internal cylinder.

Here, the circular groove and the O-ring may have the same inner diameter, whereby the O-ring is not expanded when it is inserted into the circular groove.

Further, the O-ring may have a plurality of protrusions formed thereon. The protrusions may be formed on an outer circumference surface of the O-ring to be spaced apart from each other in a circumferential direction at regular intervals.

Furthermore, a total thickness of the O-ring including the protrusions may be larger than a width of the circular groove.

### BRIEF DESCRIPTION OF THE SEVERAL VIEWS OF THE DRAWINGS

FIG. 1 is a partial sectional view of an upper portion of a self leveling damper according to a prior art;

FIG. 2 is an enlarged sectional view showing a sealing structure of the self leveling damper according to the prior art;

FIG. 3 is an enlarged sectional view showing a sealing structure of a self leveling damper according to an embodiment of the present invention; and

FIG. 4 is a perspective view of a quadrangular-sectioned O-ring used in the sealing structure of the self leveling damper according to an embodiment of the present invention.

### DETAILED DESCRIPTION

Hereinafter, a preferred embodiment of the present invention will be described in detail with reference to the accompanying drawings. The drawings provided for illustrating the present invention are for illustrative purposes, so that the illustration for elements which are not related directly to features of the present invention will be omitted for convenience.

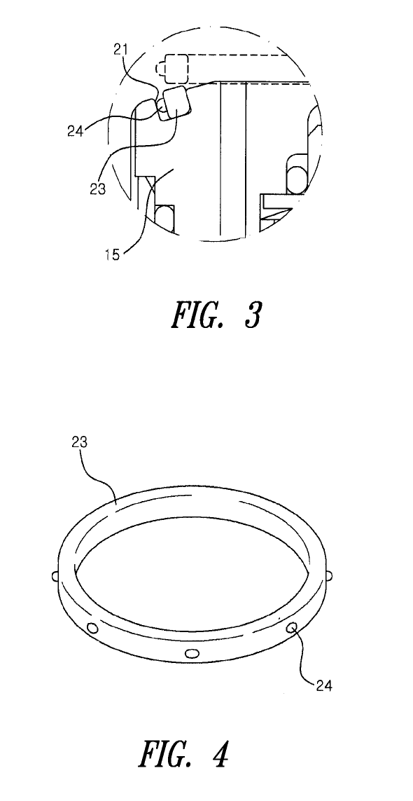

FIG. 3 is an enlarged sectional view showing a sealing structure of a self leveling damper according to the present invention, and FIG. 4 is a perspective view of a quadrangular-sectioned O-ring used in the sealing structure of the self leveling damper according to the present invention.

As shown in FIGS. 3 and 4, according to the sealing structure of the self leveling damper of vehicle according to one embodiment, a quadrangular-sectioned O-ring 23 is inserted into a circular groove 21 formed on a body of a base valve 15, so that a gap between the base valve 15 and an internal cylinder 11 is hermetically sealed.

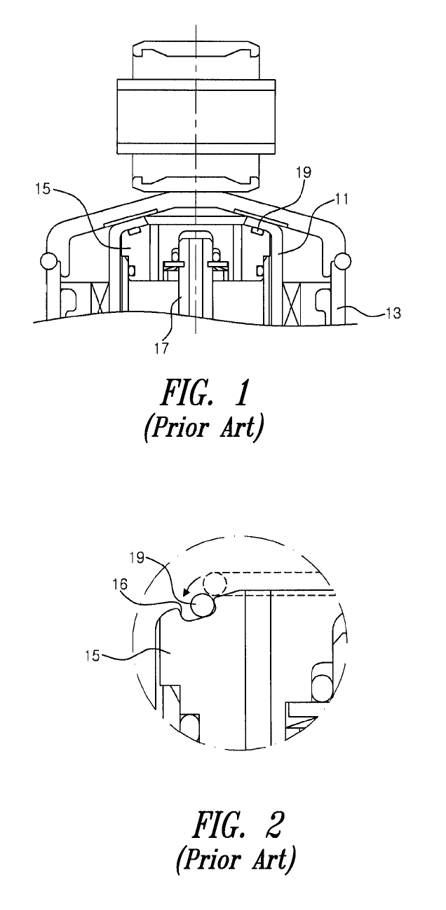

In order to mount the O-ring 23 as shown in FIG. 3, the circular groove 21 formed on the body of the base valve 15 has an inner diameter of 26.8 mm, a width of 2.5 mm and a depth of 2.4 mm and the quadrangular-sectioned O-ring 23 to be inserted in the circular groove 21 has an inner diameter of 26.8 mm, a thickness of cross section of 2.5 mm and a height of 3.0 mm. Accordingly, unlike the conventional damper shown in FIGS. 1 and 2, there is no need to expand the O-ring 23 to insert the O-ring 23 in the circular groove 21.

The dimensions of the respective regions of the circular groove 21 and the quadrangular-sectioned O-ring 23 are only for illustrative purposes and the present invention is not limited thereto.

It is preferable that a plurality of hemispherical protrusions 24 be formed on an outer circumference surface of the quadrangular-sectioned O-ring 23. In this embodiment, eight protrusions 24 are formed to be spaced apart from each other at regular intervals in an outer circumferential direction of the O-ring. The height of the protrusion 24 is determined so that the total thickness of the quadrangular-sectioned O-ring 23 including the protrusion 24 is larger than the width of the circular groove 21. In this embodiment, the height of the protrusion is approximately 0.9 mm.

Although it is shown in the figures that the protrusions 24 are formed on the outer circumference surface of the O-ring 23, the protrusions may be formed on an inner circumference surface of the O-ring. However, it is preferred that the protrusions be formed on the outer circumference surface of the O-ring 23, because the protrusions formed thereon increases the friction force between a wall surface of the circular groove 21 and the inner circumference surface of the O-ring to thereby more securely mount the O-ring. In addition, besides the hemispherical shape, the protrusion may have various shapes.

In one embodiment, the total thickness of the O-ring including the protrusion 24 can be approximately 2.7 mm, which is larger than the width of the circular groove 21 by approximately 0.2 mm. Accordingly, when the O-ring 23 is inserted into the circular groove 21, the O-ring is slightly compressed in the circular groove, so that the O-ring 23 can be prevented from escaping from the circular groove.

If there is no protrusion and the thickness of the O-ring 23 is larger than the width of the circular groove 21, there is concern that the mountability of the O-ring to the circular groove 21 may be lowered. However, embodiments of the present invention, such as the one described above, are advantageous in that the O-ring can be easily inserted in the circular groove while the protrusions 24 are deformed when the O-ring is mounted since the plurality of protrusions 24 are formed on the outer circumference surface of the O-ring 23 and the total thickness of the O-ring 23 including the protrusion 24 is larger than the width of the circular groove 21.

According to one embodiment of the present invention, the circular groove 21 formed on the body of the base valve 15 is deeper and narrower than that in the conventional structure. Such a configuration causes the O-ring 23 to be more securely mounted.

Further, in the conventional sealing structure, since the inner diameter of the circular groove is larger than that of the quadrangular-sectioned O-ring and thus the O-ring is inserted into the circular groove after being expanded, there is a restoring force by which the expanded O-ring is restored to the origin shape. Accordingly, there is concern that the O-ring may escape from the circular groove even by a small force applied to the O-ring inwardly from the outside.

However, unlike the conventional sealing structure, since the circular groove 21 and the quadrangular-sectioned O-ring 23 according to embodiments of the present invention have the substantially same inner diameter, there is no need to expand the O-ring 23 to be inserted into the circular groove 21 and there is no restoring force in the O-ring 23. Accordingly, there is no concern that the O-ring 23 does not escape from the circular groove 21 although an external force is applied to the O-ring 23 inwardly from the outside.

As described above, according to embodiments of the present invention, there is provided a sealing structure of a self leveling damper, in which a quadrangular-sectioned O-ring is mounted between a base valve and an inner cylinder for hermetically sealing the gap therebetween so that the O-ring can be prevented from escaping and a sealing status of the O-ring can be stably maintained.

Although an embodiment of the present invention has been described, it will be apparent to those skilled in the art that various modifications, changes and variations can be made thereto within the scope of the present invention and the appended claims. Therefore, the aforementioned descriptions and the accompanying drawings should be construed as not limiting the technical spirit of the present invention but illustrating the present invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A sealing structure for hermetically sealing a gap between a base valve and an internal cylinder in a self leveling damper, which includes internal and external cylinders, a piston valve and a piston rod provided in the internal cylinder, and the base valve provided in a distal end of the internal cylinder, the sealing structure comprising:
a quadrangular-sectioned O-ring inserted into a circular groove formed on a body of the base valve to hermetically seal the gap between the base valve and the internal cylinder.

2. The sealing structure as claimed in claim 1 wherein the circular groove and the O-ring have the same inner diameter, whereby the O-ring is not expanded when it is inserted into the circular groove.

3. The sealing structure as claimed in claim 1 wherein the O-ring has a plurality of protrusions formed thereon.

4. The sealing structure as claimed in claim 3 wherein the protrusions are formed on an outer circumference surface of the O-ring to be spaced apart from each other in a circumferential direction at regular intervals.

5. The sealing structure as claimed in claim 3 wherein a total thickness of the O-ring including the protrusions is larger than a width of the circular groove.
